(19) United States
(12) Patent Application Publication
(10) Pub. No.: US 2012/0268976 A1
(43) Pub. Date: Oct. 25, 2012

(54) THREE-PHASE RECTIFIER CIRCUIT

(75) Inventors: Chao Yan, Shanghai (CN); Wenxin Zhang, Shanghai (CN); Yiqing Ye, Shanghai (CN); Jianping Ying, Shanghai (CN)

(73) Assignee: DELTA ELECTRONICS (SHANGHAI) CO., LTD., Shanghai (CN)

(21) Appl. No.: 13/544,695

(22) Filed: Jul. 9, 2012

Related U.S. Application Data
(63) Continuation-in-part of application No. 13/090,925, filed on Apr. 20, 2011.
Application No. 13/090,925 is a continuation of application No. 12/394,571, filed on Feb. 27, 2009, now abandoned.

(30) Foreign Application Priority Data
May 14, 2012 (CN) 201210149108.8

(51) Int. Cl. H02M 7/06

(52) U.S. Cl. 363/126

(57) ABSTRACT

In one aspect of the invention, a three-phase rectifier circuit having three input terminals and two output terminals includes a three-phase diode bridge, three switching circuits, and a voltage source. The three-phase diode bridge has three pairs of first diodes electrically parallel-connected to the two output terminals. Each pair of first diodes has two first diodes series-connected defining a first node therebetween, and electrically connected to a corresponding input terminal at the first node. Each switching circuit has a first terminal, a second terminal and a plurality of switches electrically series-connected between the first and second terminals. The first and second terminals are respectively electrically connected to a second node and a third node, respectively between the first node and the two first diodes of the corresponding pair of first diodes. The voltage source is electrically parallel-connected between the two output terminals and electrically connected to each switching circuit.

### CROSS-REFERENCE TO RELATED PATENT APPLICATION

This application is a continuation-in-part application of a co-pending U.S. patent application Ser. No. 13/090,925, filed on Apr. 20, 2011, entitled

“PARALLEL-CONNECTED RESONANT CONVERTER CIRCUIT AND CONTROLLING METHOD THEREOF”, by Haoyi Ye et al., which itself is a continuation application of U.S. patent application Ser. No. 12/394,571, Feb. 27, 2009, entitled “PARALLEL-CONNECTED RESONANT CONVERTER CIRCUIT AND CONTROLLING METHOD THEREOF”, by Haoyi Ye et al., which status is abandoned and which itself claims priority to and the benefit of, pursuant to 35 U.S.C. §119(a), Taiwan patent application No. 097109222, filed on Mar. 14, 2008, entitled “PARALLEL-CONNECTED RESONANT CONVERTER CIRCUIT AND CONTROLLING METHOD THEREOF”, by Haoyi Ye et al., all of the contents of which are incorporated herein by reference in their entireties.

This application also claims priority to and the benefit of, pursuant to 35 U.S.C. §119(a), Chinese patent application No. 201210149108.8, filed May 14, 2012, entitled “CONVERTER WITH INPUT VOLTAGE BALANCE CIRCUIT”, by Chao Yan et al., the content of which is incorporated herein by reference in its entirety.

### FIELD OF THE INVENTION

The present invention generally relates to an AC/DC converter circuit, and more particularly, to a three-phase rectifier circuit that utilizes a three-phase power factor correction (PFC) circuit to rectify AC input voltages to DC voltages.

### BACKGROUND OF THE INVENTION

An AC/DC converter is an electronic device that converts a source of alternating current (AC) signals to direct current (DC) signals. The AC/DC converters are important in electronic devices that utilize DC voltages to operate with AC power as the power source, such as computer servers or workstations. Furthermore, other electronic devices using both AC power and chargeable batteries as power sources are also in need of the AC/DC converters. For example, portable electronic devices such as cellular phones and laptop computers may use DC power supplied from the batteries when AC power is not available, but may also use AC power as a power source to operate and/or to charge the batteries. In this case, the AC voltages must be converted to DC voltages for the operation of the portable electronic devices or charging of the batteries.

Generally, AC/DC converters utilize power factor correction (PFC) circuits because of the increasing resonance requirement of the voltage signals and the conversion efficiency of the PFC circuit. A conventional AC/DC converter utilizes a single phase system, which comprises a single-phase PFC circuit, a high voltage DC link, and a DC/DC converter. The single-phase PFC circuit performs the AC/DC conversion, converting AC voltages from the AC power source to high voltage DC signals and sends the high voltage DC signals to the DC/DC converter through the high voltage DC link. The DC/DC converter then converts the high voltage DC signals to the desired DC voltages for the electronic devices. However, the output power rate of the single phase system is limited.

With the increasing requirement of high output power rate of the

AC/DC converters, the three-phase PFC circuits are widely used to perform the AC/DC conversion. In practical use, topology of the three-phase PFC circuits can be in a variety of different circuitry layouts. A simple circuitry layout of the three-phase PFC circuit is always preferred, but the simple circuitry layout generally leads to problems such as relatively low efficiency and high resonant wave current. On the other hand, adopting more complicated circuitry layouts to increase the efficiency of the three-phase PFC circuits would create a different set of problems, such as increased cost and complexity of control of the circuitry, and reduced reliability of the AC/DC converters.

Further, the three-phase PFC circuits generate a higher output DC voltage, generally in the range of 800V. Thus, when the AC/DC converters use the three-phase PFC circuits instead of the single-phase PFC circuits, the DC/DC converter must be replaced to sustain the higher output DC voltage generated by the three-phase PFC circuits. One way to solve the problem is to utilize high voltage circuitry elements, such as 1200V elements, instead of the 600V elements in the AC/DC converters. However, the 1200V elements are not as commonly used as the 600V elements, and the AC/DC converters would thus cost more due to the increased cost of the 1200V elements. Another way is to utilize more complicated circuitry layouts with the general 600V elements. In this way, however, the number of circuitry elements would increase and thus become more difficult to control.

Therefore, a heretofore unaddressed need exists in the art to address the aforementioned deficiencies and inadequacies.

### SUMMARY OF THE INVENTION

The present invention, in one aspect, relates to a three-phase rectifier circuit having three input terminals and two output terminals. In one embodiment, the three-phase rectifier circuit includes a three-phase diode bridge, three switching circuits, and a voltage source electrically coupled to one another.

The three-phase diode bridge has three pairs of first diodes electrically parallel-connected to the two output terminals. Each pair of first diodes has two first diodes series-connected defining a first node therebetween, and electrically connected to a corresponding input terminal at the first node. In one embodiment, all the first diodes of the three pairs of first diodes comprise fast recovery diodes. In another embodiment, the three-phase diode bridge further comprises three pairs of second diodes. Each pair of second diodes has two second diodes, one second diode is electrically connected between the first node and the second node of the corresponding pair of first diodes, and the other second diode is electrically connected between the first node and the third node of the corresponding pair of first diodes. In yet another embodiment, all the first diodes of the three pairs of first diodes comprise fast recovery diodes, and all the second diodes of the three pairs of second diodes comprise slow recovery diodes.

Each switching circuit has a first terminal, a second terminal and a plurality of switches electrically series-connected between the first and second terminals. Each switching circuit is coupled to a corresponding pair of first diodes such that the first terminal is electrically connected to a second node between the first node and one first diode of the corresponding pair of first diodes and the second terminal is electrically connected to a third node between the first node and the other first diode of the corresponding pair of first diodes. In one embodiment, each of the plurality of switches of the three switching circuits comprises a metal-oxide-semiconductor (MOS) switch or an insulated-gate bipolar transistor (IGBT) switch.

The voltage source is electrically parallel-connected between the two output terminals and electrically connected to each switching circuit. In one embodiment, the voltage source comprises two polarized capacitors series-connected defining a fourth node therebetween, and electrically connected to each of the switching circuits at the fourth node.

Further, the three-phase rectifier circuit may include a converter circuit electrically connected to the output terminals. The converter circuit may also have a plurality of modules, and each module has a first input, a second input, a first output and a second output. The first input of the first module and the second input of the last module are respectively electrically connected to the output terminals, the second input of any one but the last module is electrically connected to the first input of its immediate next module, and all the first outputs and the second outputs of the plurality of modules are electrically parallel-connected. In one embodiment, each of the modules has a resonant converter. Additionally, the resonant converter may have an LLC series resonant DC/DC converter or an LLC parallel resonant DC/DC converter.

In another aspect of the present invention, a three-phase rectifier circuit having three input terminals and two output terminals includes a three-phase diode bridge and three switching circuits. The three-phase diode bridge has three pairs of first diodes electrically parallel-connected to the two output terminals, where each pair of first diodes comprises two first diodes series-connected defining a first node therebetween, and electrically connected to a corresponding input terminal at the first node. Each switching circuit has a first terminal, a second terminal and a plurality of switches electrically series-connected between the first and second terminals, and is coupled to a corresponding pair of first diodes such that the first terminal is electrically connected to a second node between the first node and one first diode of the corresponding pair of first diodes and the second terminal is electrically connected to a third node between the first node and the other first diode of the corresponding pair of first diodes. In one embodiment, each of the plurality of switches of the three switching circuits includes an MOS switch or an IGBT switch.

Further, the three-phase diode bridge may have three pairs of second diodes, where each pair of second diodes has two second diodes, one second diode is electrically connected between the first node and the second node of the corresponding pair of first diodes, and the other second diode is electrically connected between the first node and the third node of the corresponding pair of first diodes. In one embodiment, all the first diodes of the three pairs of first diodes include fast recovery diodes, and all the second diodes of the three pairs of second diodes include slow recovery diodes.

Additionally, the three-phase rectifier circuit may have a voltage source electrically parallel-connected between the two output terminals and electrically connected to each switching circuit. In one embodiment, the voltage source comprises two polarized capacitors series-connected defining a fourth node therebetween, and electrically connected to each of the switching circuits at the fourth node.

Moreover, the three-phase rectifier circuit may include a converter circuit electrically connected to the output terminals. The converter circuit may also have a plurality of modules, and each module has a first input, a second input, a first output and a second output. The first input of the first module and the second input of the last module are respectively electrically connected to the output terminals, the second input of any one but the last module is electrically connected to the first input of its immediate next module, and all the first outputs and the second outputs of the plurality of modules are electrically parallel-connected. In one embodiment, each of the modules has a resonant converter. Additionally, the resonant converter may have an LLC series resonant DC/DC converter or an LLC parallel resonant DC/DC converter.

In yet another aspect of the present invention, a three-phase rectifier circuit having three input terminals and two output terminals includes a three-phase diode bridge and three switching circuits. In one embodiment, the three-phase rectifier circuit has a PFC circuit having one or more inputs electrically coupled to an AC power source, and two outputs, a voltage source electrically coupled between the two outputs of the PFC, and a plurality of modules interleavingly connected to each other, and electrically coupled to the voltage source.

In one embodiment, the PFC circuit comprises a three-phase diode bridge comprising three pairs of first diodes electrically parallel-connected to the two outputs of the PFC circuit, wherein each pair of first diodes comprises two first diodes series-connected defining a first node therebetween, and electrically connected to a corresponding input of the PFC circuit at the first node, and three switching circuits, each switching circuit having a first terminal, a second terminal and a plurality of switches electrically series-connected between the first and second terminals, coupled to a corresponding pair of first diodes such that the first terminal is electrically connected to a second node between the first node and one first diode of the corresponding pair of first diodes and the second terminal is electrically connected to a third node between the first node and the other first diode of the corresponding pair of first diodes.

In one embodiment, the voltage source comprises one or more polarized capacitors.

In one embodiment, each module has a first input, a second input, a first output and a second output, wherein the first input of the first module and the second input of the last module are electrically coupled to the outputs of the PFC circuit, the second input of any one but the last module is electrically connected to the first input of its immediate next module, and all the first outputs and the second outputs of the plurality of modules are electrically parallel-connected. In one embodiment, each of the modules comprises a resonant converter, where the resonant converter comprises an LLC series resonant DC/DC converter or an LLC parallel resonant DC/DC converter.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 shows a specific circuit diagram of a three-phase rectifier circuit according to one embodiment of the present invention;

FIG. 2 shows a specific circuit diagram of a three-phase rectifier circuit according to another embodiment of the present invention;

FIG. 3 shows a specific circuit diagram of a three-phase rectifier circuit according to yet another embodiment of the present invention;

FIG. 4 shows a specific circuit diagram of a three-phase rectifier circuit according to a further embodiment of the present invention; and

FIG. 5 shows a schematic diagram of a three-phase rectifier circuit according to one embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

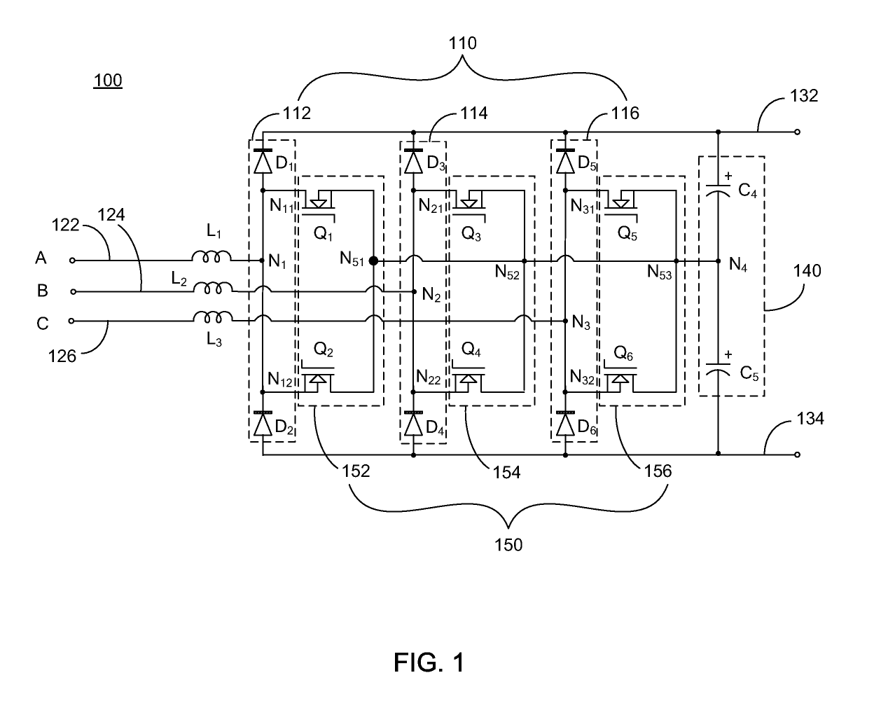

The description will be made as to the embodiments of the present invention in conjunction with the accompanying drawings in FIGS. 1-5. In accordance with the purposes of this invention, as embodied and broadly described herein, this invention, in one aspect, relates to a three-phase rectifier circuit. The three-phase rectifier circuit in one embodiment is a three-phase PFC circuit.

FIGS. 1-4 show respectively four specific circuits of a three-phase rectifier circuit 100, 200, 300 and 400 according to different embodiments of the present invention. As shown in FIG. 1, the three-phase rectifier circuit 100 has three input terminals 122, 124 and 126 and two output terminals 132 and 134. The three input terminals 122, 124 and 126 can be AC input terminals and each has an inductor L₁, L₂ or L₃. The two output terminals 132 and 134 can be DC output terminals. Further, the three-phase rectifier circuit 100 has a three-phase diode bridge 110, a voltage source 140, and three switching circuits 150. The three-phase diode bridge 110 shown in FIG. 1 is bridge rectifiers, and more specifically, a three-phase Vienna PFC circuit. Also, the three-phase diode bridge 110 has three pairs of first diodes 112, 114 and 116 electrically parallel-connected to the two output terminals 132 and 134.

The pair of the first diodes 112 includes first diodes D₁ and D₂ series-connected defining a first node N₁ therebetween, and electrically connected to the corresponding input terminal 122 at the first node N₁. Similarly, the pair of the first diodes 114 includes first diodes D₃ and D₄ series-connected defining a first node N₂ therebetween, and electrically connected to the corresponding input terminal 124 at the first node N₂. The pair of the first diodes 116 includes first diodes D₅ and D₆ series-connected defining a first node N₃ therebetween, and electrically connected to the corresponding input terminal 126 at the first node N₃. Preferably, all the first diodes D₁, D₂, D₃, D₄, D₅ and D₆ of the three pairs of first diodes 112, 114 and 116 include fast recovery diodes.

The three switching circuits 150 include switching circuits 152, 154 and 156. The switching circuit 152 has a first terminal, a second terminal and a plurality of switches Q₁ and Q₂ electrically series-connected between the first and second terminals, and is coupled to a corresponding pair of first diodes 112 such that the first terminal is electrically connected to a second node N₁₁ between the first node N₁ and one first diode D₁ of the corresponding pair of first diodes 112 and the second terminal is electrically connected to a third node N₁₂ between the first node N₁ and the other first diode D₂ of the corresponding pair of first diodes 112. Similarly, the switching circuit 154 also has a first terminal, a second terminal and a plurality of switches Q₃ and Q₄ electrically series-connected between the first and second terminals, and is coupled to a corresponding pair of first diodes 114 such that the first terminal is electrically connected to a second node N₂₁ between the first node N₂ and one first diode D₃ of the corresponding pair of first diodes 114 and the second terminal is electrically connected to a third node N₂₂ between the first node N₂ and the other first diode D₄ of the corresponding pair of first diodes 114. The switching circuit 156 also has a first terminal, a second terminal and a plurality of switches Q₅ and Q₆ electrically series-connected between the first and second terminals, and is coupled to a corresponding pair of first diodes 116 such that the first terminal is electrically connected to a second node N₃₁ between the first node N₃ and one first diode D₅ of the corresponding pair of first diodes 116 and the second terminal is electrically connected to a third node N₃₂ between the first node N₃ and the other first diode D₆ of the corresponding pair of first diodes 116. In FIG. 1, all the switches Q₁, Q₂, Q₃, Q₄, Q₅ and Q₆ of the three switching circuits 152, 154 and 156 include MOS switches.

The voltage source 140 is electrically parallel-connected between the two output terminals 132 and 134 and electrically connected to each switching circuit 112, 114 and 116 at nodes N₅₁, N₅₂, and N₅₃. Specifically, the voltage source 140 has two polarized capacitors (energy storage capacitors) C₄ and C₅ series-connected defining a fourth node N₄ therebetween, and electrically connected to each of the switching circuits 112, 114 and 116 at the fourth node N₄.

According to the embodiment shown in FIG. 1, the three-phase rectifier circuit 100 utilizes only six diodes (the first diodes D₁, D₂, D₃, D₄, D₅ and D₆ of the three pairs of first diodes 112, 114 and 116) and six MOS switches (the switches Q₁, Q₂, Q₃, Q₄, Q₅ and Q₆ of the three switching circuits 152, 154 and 156). Thus, the circuitry elements required in the three-phase rectifier circuit 100 would be fewer than those required in the typical three-phase PFC circuits.

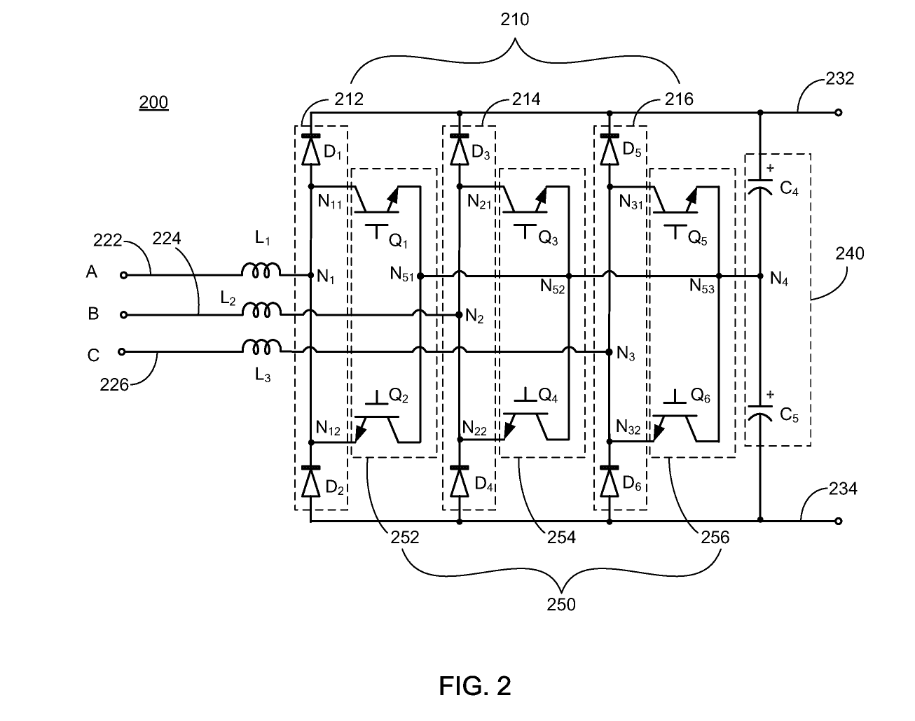

FIG. 2 shows a specific circuit diagram of a three-phase rectifier circuit 200 according to another embodiment of the present invention, which is essentially the same as the three-phase rectifier circuit 100 in FIG. 1, and thus all the elements are numerated with similar numerals. For example, as shown in FIG. 2, the three-phase rectifier circuit 200 has three input terminals 222, 224 and 226 and two output terminals 232 and 234. Further, the three-phase rectifier circuit 200 has a three-phase diode bridge 210, a voltage source 240, and three switching circuits 250.

Also, the three-phase diode bridge 210 has three pairs of first diodes 212, 214 and 216 electrically parallel-connected to the two output terminals 232 and 234, and the three switching circuits 250 include switching circuits 252, 254 and 256. The embodiment in FIG. 2 is different from the embodiment in FIG. 1 in that all the switches Q₁, Q₂, Q₃, Q₄, Q₅ and _{Q}₆ of the three switching circuits 252, 254 and 256 in FIG. 2 include IGBT switches. Other elements and features of the embodiment in FIG. 2 are essentially the same as the embodiment in FIG. 1, and the detailed description is thus omitted.

According to the embodiment shown in FIG. 2, the three-phase rectifier circuit 200 utilizes only six diodes (the first diodes D₁, D₂, D₃, D₄, D₅ and D₆ of the three pairs of first diodes 212, 214 and 216) and six IGBT switches (the switches Q₁, Q₂, Q₃, Q₄, Q₅ and Q₆ of the three switching circuits 252, 254 and 256). Thus, the circuitry elements required in the three-phase rectifier circuit 200 would be fewer than those required in the typical three-phase PFC circuits.

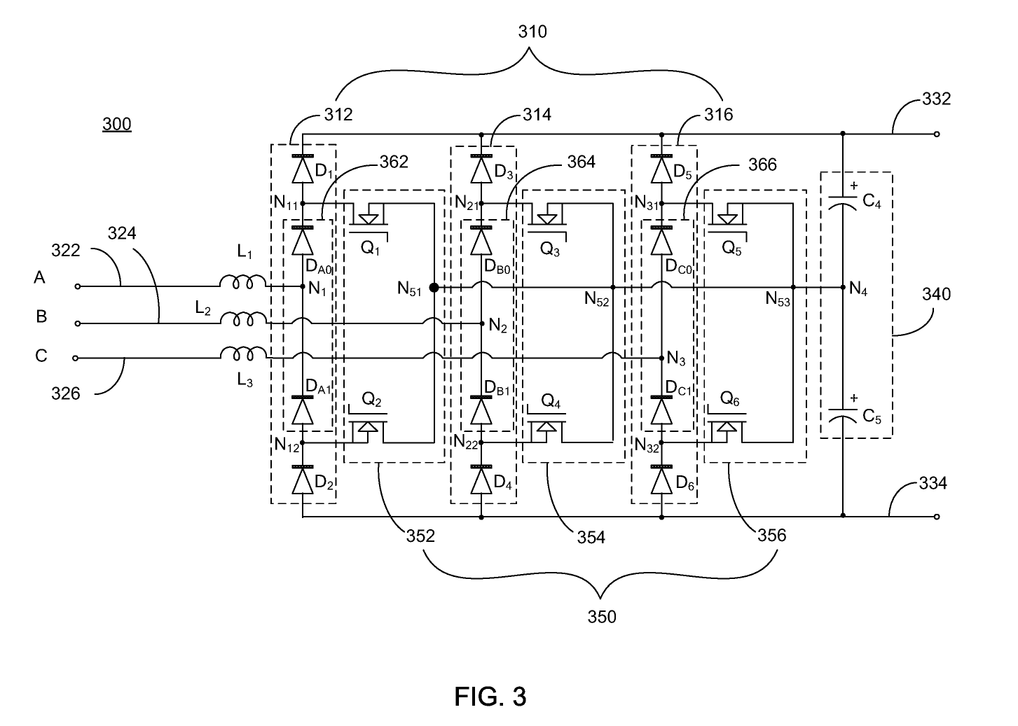

FIG. 3 shows a specific circuit diagram of a three-phase rectifier circuit 300 according to yet another embodiment of the present invention, which is similar to the three-phase rectifier circuit 100 in FIG. 1, and thus all the elements are numerated with similar numerals. For example, as shown in FIG. 3, the three-phase rectifier circuit 300 has three input terminals 322, 324 and 326 and two output terminals 332 and 334. Further, the three-phase rectifier circuit 300 has a three-phase diode bridge 310, a voltage source 340, and three switching circuits 350. Also, the three-phase diode bridge 310 has three pairs of first diodes 312, 314 and 316 electrically parallel-connected to the two output terminals 332 and 334, and the three switching circuits 350 include switching circuits 352, 354 and 356. The embodiment in FIG. 3 is different from the embodiment in FIG. 1 in that the three-phase diode bridge 310 further includes three pairs of second diodes 362, 364 and 366. The pair of second diodes 362 includes two second diodes D_{A0} and D_{A1}, one second diode D_{A0} is electrically connected between the first node N₁ and the second node N₁₁ of the corresponding pair of first diodes 312, and the other second diode D_{A1} is electrically connected between the first node N₁ and the third node N₁₂ of the corresponding pair of first diodes 312. Similarly, the pair of second diodes 364 includes two second diodes D_{B0} and D_{B1}, one second diode D_{B0} is electrically connected between the first node N₂ and the second node N₂₁ of the corresponding pair of first diodes 314, and the other second diode D_{B1} is electrically connected between the first node N₂ and the third node N₂₂ of the corresponding pair of first diodes 314. The pair of second diodes 366 includes two second diodes D_{C0} and D_{C1}, one second diode D_{C0} is electrically connected between the first node N₃ and the second node N₃₁ of the corresponding pair of first diodes 316, and the other second diode D_{C1} is electrically connected between the first node N₃ and the third node N₃₂ of the corresponding pair of first diodes 316. Preferably, all the first diodes D₁, D₂, D₃, D₄, D₅ and D₆ of the three pairs of first diodes 312, 314 and 316 include fast recovery diodes, and all the second diodes D_{A0}, D_{A1}, D_{B0}, D_{B1}, D_{C0} and D_{C1} of the three pairs of second diodes 362, 364 and 366 include slow recovery diodes.

According to the embodiment shown in FIG. 3, the three-phase rectifier circuit 300 utilizes twelve diodes (the first diodes D₁, D₂, D₃, D₄, D₅ and D₆ of the three pairs of first diodes 312, 314 and 316, and the second diodes D_{A0}, D_{A1}, D_{B0}, D_{B1}, D_{C0} and D_{C1} of the three pairs of second diodes 362, 364 and 366) and six MOS switches (the switches Q₁, Q₂, Q₃, Q₄, Q₅ and Q₆ of the three switching circuits 352, 354 and 356), more than the six diodes and the six switches utilized in FIG. 1. However, the total circuitry elements required in the three-phase rectifier circuit 300 would still be fewer than those required in the typical three-phase PFC circuits. Moreover, the additional three pairs of second diodes 362, 364 and 366 allows the three-phase rectifier circuit 300 to utilize standard voltage circuitry elements, such as the commonly used 600V elements, instead of the high voltage 1200V elements. Thus, the three-phase rectifier circuit 300 can realize high efficiency with a reduced cost of circuitry elements.

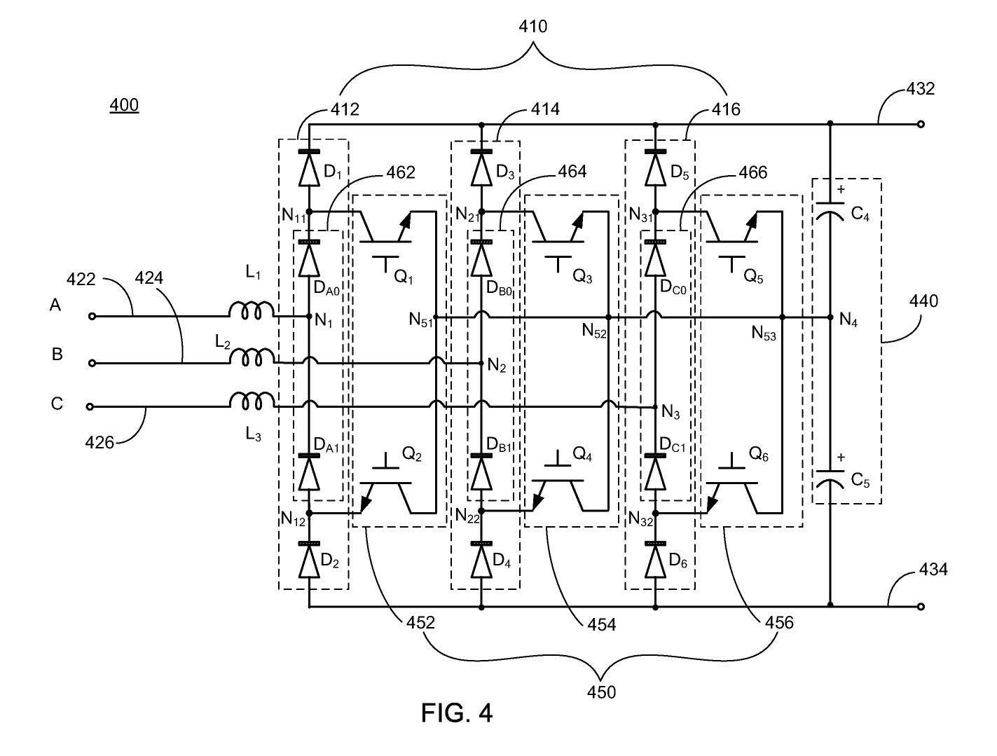

FIG. 4 shows a specific circuit diagram of a three-phase rectifier circuit 400 according to another embodiment of the present invention, which is essentially the same as the three-phase rectifier circuit 300 in FIG. 3, and thus all the elements are numerated with similar numerals. For example, as shown in FIG. 4, the three-phase rectifier circuit 400 has three input terminals 422, 424 and 426 and two output terminals 432 and 434. Further, the three-phase rectifier circuit 400 has a three-phase diode bridge 410, a voltage source 440, and three switching circuits 450. Also, the three-phase diode bridge 410 has three pairs of first diodes 412, 414 and 416 electrically parallel-connected to the two output terminals 432 and 434, and the three switching circuits 250 include switching circuits 452, 454 and 456. The three-phase diode bridge 410 further includes three pairs of second diodes 462, 464 and 466. The embodiment in FIG. 4 is different from the embodiment in FIG. 3 in that all the switches Q₁, Q₂, Q₃, Q₄, Q₅ and Q₆ of the three switching circuits 452, 454 and 456 in FIG. 4 include insulated-gate bipolar transistor (IGBT) switches. Other elements and features of the embodiment in FIG. 4 are essentially the same as the embodiment in FIG. 3, and the detailed description is thus omitted.

According to the embodiment shown in FIG. 4, the three-phase rectifier circuit 400 utilizes twelve diodes (the first diodes D₁, D₂, D₃, D₄, D₅ and D₆ of the three pairs of first diodes 412, 414 and 416, and the second diodes D_{A0}, D_{A1}, D_{B0}, D_{B1}, D_{C0} and D_{C1} of the three pairs of second diodes 462, 464 and 466) and six IGBT switches (the switches Q₁, Q₂, Q₃, Q₄, Q₅ and Q₆ of the three switching circuits 452, 454 and 456), more than the six diodes and the six switches utilized in FIG. 2. However, the total circuitry elements required in the three-phase rectifier circuit 400 would still be fewer than those required in the typical three-phase PFC circuits. Moreover, the additional three pairs of second diodes 362, 364 and 366 allows the three-phase rectifier circuit 400 to utilize standard voltage circuitry elements, such as the commonly used 600V elements, instead of the high voltage 1200V elements. Thus, the three-phase rectifier circuit 400 can realize high efficiency with a reduced cost of circuitry elements.

According to the embodiments shown in FIGS. 1-4, the three-phase rectifier circuit of the present invention may maintain a simple circuitry layout without reducing the efficiency of the converter or increasing the resonant wave current. In addition, the total number of the circuitry elements required in the three-phase rectifier circuit can be reduced comparing to those required in the typical three-phase PFC circuits. Thus, the cost and complexity of control of the circuitry may be relatively low, and reliability of the three-phase rectifier circuit can be maintained.

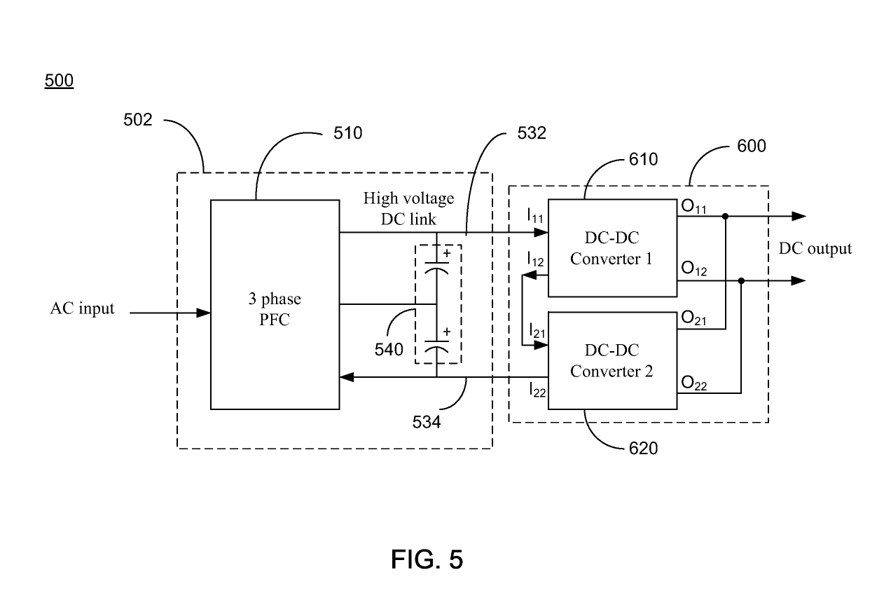

FIG. 5 shows a schematic diagram of a three-phase rectifier circuit 500 according to one embodiment of the present invention. As shown in FIG. 5, the three-phase rectifier circuit 500 has an AC/DC rectifier circuit 502 and a converter circuit 600. The AC/DC rectifier circuit 502 can be essentially any the three-phase rectifier circuits 100-400 of the embodiments shown in FIGS. 1-4, or any other embodiment or implementation of the three-phase rectifier circuit of the present invention. In FIG. 5, the AC/DC rectifier circuit 502 has a three-phase PFC circuit 510 and a voltage source 540. The three-phase PFC circuit 510 serves as the three-phase diode bridge of the present invention, and has two output terminals 532 and 534. The output terminals 532 and 534 are electrically coupled to the converter circuit 600 via a high voltage DC link or a DC bus. Other details of the three-phase PFC circuit 510 and the three switching circuits connected in the three-phase diode bridge are not shown in FIG. 5, and the three input terminals of the three-phase diode bridge is shown in a schematic AC input. The voltage source 540 in the exemplary embodiment shown in FIG. 5 includes two polarized capacitors electrically connected in series. The voltage source 540 can also be formed of other types of capacitors, such as energy-storage capacitors.

The converter circuit 600 is essentially a DC/DC converter electrically connected to the output terminals 532 and 534 of the three-phase PFC circuit 510. According to the present invention, the converter circuit 600 includes a plurality of modules, and each module has a first input, a second input, a first output and a second output. Specifically, the converter circuit 600 in FIG. 5 includes two DC/DC converters 610 and 620. The first DC/DC converter 610 has a first input I₁₁, a second input I₁₂, a first output O₁₁ and a second output O₁₂. Similarly, the second DC/DC converter 620 also has a first input I₂₁, a second input I₂₂, a first output O₂₁ and a second output O₂₂. All the first outputs O₁₁ and O₂₁ and the second outputs O₁₂ and O₂₂ of the DC/DC converters (or the plurality of modules) are electrically parallel-connected to the DC output.

According to the present invention, the first input of the first module and the second input of the last module are respectively electrically connected to the output terminals, and the second input of any one but the last module is electrically connected to the first input of its immediate next module. In the exemplary embodiment shown in FIG. 5, the first input I₁₁ of the first DC/DC converter 610 (the first module) and the second input I₂₂ of the second DC/DC converter 620 (the last module) are respectively electrically connected to the output terminals 532 and 534 of the three-phase PFC circuit 510. The second input I₁₂ of the first DC/DC converter 610 (any one but the last module) is electrically connected to the first input I₂₁ of the second DC/DC converter 620 (the immediate next module of the first DC/DC converter 610).

It should be appreciated to those of skill in the art that, in the converter circuit, the modules may be resonant converters, and the resonant converter may include an LLC series resonant DC/DC converter or an LLC parallel resonant DC/DC converter, or any other types or configurations of the resonant converter circuits. Also, the converter circuit may include more than two resonant converters, or any other types of modules.

In sum, the present invention, among other things, recites a three-phase rectifier circuit that has three input terminals and two output terminals. The three-phase rectifier circuit includes a three-phase diode bridge having three pairs of first diodes electrically parallel-connected to the two output terminals, where each pair of first diodes comprises two first diodes series-connected defining a first node therebetween, and electrically connected to a corresponding input terminal at the first node, and three switching circuits, each switching circuit having a first terminal, a second terminal and a plurality of switches electrically series-connected between the first and second terminals, coupled to a corresponding pair of first diodes such that the first terminal is electrically connected to a second node between the first node and one first diode of the corresponding pair of first diodes and the second terminal is electrically connected to a third node between the first node and the other first diode of the corresponding pair of first diodes. In one aspect, the three-phase rectifier circuit further includes a voltage source electrically parallel-connected between the two output terminals and electrically connected to each switching circuit. In another aspect, the three-phase diode bridge further includes three pairs of second diodes, where each pair of second diodes comprises two second diodes, one second diode is electrically connected between the first node and the second node of the corresponding pair of first diodes, and the other second is electrically connected between the first node and the third node of the corresponding pair of first diodes.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A three-phase rectifier circuit having three input terminals and two output terminals, the three-phase rectifier circuit comprising:
(a) a three-phase diode bridge comprising three pairs of first diodes electrically parallel-connected to the two output terminals, wherein each pair of first diodes comprises two first diodes series-connected defining a first node therebetween, and electrically connected to a corresponding input terminal at the first node;
(b) three switching circuits, each switching circuit having a first terminal, a second terminal and a plurality of switches electrically series-connected between the first and second terminals, coupled to a corresponding pair of first diodes such that the first terminal is electrically connected to a second node between the first node and one first diode of the corresponding pair of first diodes and the second terminal is electrically connected to a third node between the first node and the other first diode of the corresponding pair of first diodes; and
(c) a voltage source electrically parallel-connected between the two output terminals and electrically connected to each switching circuit.

2. The three-phase rectifier circuit of claim 1, wherein all the first diodes of the three pairs of first diodes comprise fast recovery diodes.

3. The three-phase rectifier circuit of claim 1, wherein the three-phase diode bridge further comprises three pairs of second diodes, wherein each pair of second diodes comprises two second diodes, one second diode is electrically connected between the first node and the second node of the corresponding pair of first diodes, and the other second diode is electrically connected between the first node and the third node of the corresponding pair of first diodes.

4. The three-phase rectifier circuit of claim 3, wherein all the first diodes of the three pairs of first diodes comprise fast recovery diodes, and all the second diodes of the three pairs of second diodes comprise slow recovery diodes.

5. The three-phase rectifier circuit of claim 1, wherein each of the plurality of switches of the three switching circuits comprises a metal-oxide-semiconductor (MOS) switch or an insulated-gate bipolar transistor (IGBT) switch.

6. The three-phase rectifier circuit of claim 1, wherein the voltage source comprises two polarized capacitors series-connected defining a fourth node therebetween, and electrically connected to each of the switching circuits at the fourth node.

7. The three-phase rectifier circuit of claim 1, further comprising a plurality of modules, each module having a first input, a second input, a first output and a second output, wherein the first input of the first module and the second input of the last module are respectively electrically connected to the output terminals, the second input of any one but the last module is electrically connected to the first input of its immediate next module, and all the first outputs and the second outputs of the plurality of modules are electrically parallel-connected.

8. The three-phase rectifier circuit of claim 7, wherein each of the modules comprises a resonant converter.

9. The three-phase rectifier circuit of claim 8, wherein the resonant converter comprises an LLC series resonant DC/DC converter or an LLC parallel resonant DC/DC converter.

10. A three-phase rectifier circuit having three input terminals and two output terminals, the three-phase rectifier circuit comprising:
(a) a three-phase diode bridge comprising three pairs of first diodes electrically parallel-connected to the two output terminals, wherein each pair of first diodes comprises two first diodes series-connected defining a first node therebetween, and electrically connected to a corresponding input terminal at the first node; and
(b) three switching circuits, each switching circuit having a first terminal, a second terminal and a plurality of switches electrically series-connected between the first and second terminals, coupled to a corresponding pair of first diodes such that the first terminal is electrically connected to a second node between the first node and one first diode of the corresponding pair of first diodes and the second terminal is electrically connected to a third node between the first node and the other first diode of the corresponding pair of first diodes.

11. The three-phase rectifier circuit of claim 10, wherein all the first diodes of the three pairs of first diodes comprise fast recovery diodes.

12. The three-phase rectifier circuit of claim 10, wherein the three-phase diode bridge further comprises three pairs of second diodes, wherein each pair of second diodes comprises two second diodes, one second diode is electrically connected between the first node and the second node of the corresponding pair of first diodes, and the other second diode is electrically connected between the first node and the third node of the corresponding pair of first diodes.

13. The three-phase rectifier circuit of claim 12, wherein all the first diodes of the three pairs of first diodes comprise fast recovery diodes, and all the second diodes of the three pairs of second diodes comprise slow recovery diodes.

14. The three-phase rectifier circuit of claim 10, wherein each of the plurality of switches of the three switching circuits comprises a metal-oxide-semiconductor (MOS) switch or an insulated-gate bipolar transistor (IGBT) switch.

15. The three-phase rectifier circuit of claim 10, further comprising a voltage source electrically parallel-connected between the two output terminals and electrically connected to each switching circuit.

16. The three-phase rectifier circuit of claim 15, wherein the voltage source comprises two polarized capacitors series-connected defining a fourth node therebetween, and electrically connected to each of the switching circuits at the fourth node.

17. The three-phase rectifier circuit of claim 10, further comprising a plurality of modules, each modules having a first input, a second input, a first output and a second output, wherein the first input of the first module and the second input of the last module are respectively electrically connected to the output terminals, the second input of any one but the last module is electrically connected to the first input of its immediate next module, and all the first outputs and the second outputs of the plurality of modules are electrically parallel-connected.

18. The three-phase rectifier circuit of claim 17, wherein each of the modules comprises a resonant converter.

19. The three-phase rectifier circuit of claim 18, wherein the resonant converter comprises an LLC series resonant DC/DC converter or an LLC parallel resonant DC/DC converter.

20. A three-phase rectifier circuit, comprising:
(a) a power factor correction (PFC) circuit having one or more inputs electrically coupled to an AC power source, and two outputs;
(b) a voltage source electrically coupled between the two outputs of the PFC; and
(c) a plurality of modules interleavingly connected to each other, and electrically coupled to the voltage source.

21. The three-phase rectifier circuit of claim 20, wherein the PFC circuit comprises:
(a) a three-phase diode bridge comprising three pairs of first diodes electrically parallel-connected to the two outputs of the PFC circuit, wherein each pair of first diodes comprises two first diodes series-connected defining a first node therebetween, and electrically connected to a corresponding input of the PFC circuit at the first node; and
(b) three switching circuits, each switching circuit having a first terminal, a second terminal and a plurality of switches electrically series-connected between the first and second terminals, coupled to a corresponding pair of first diodes such that the first terminal is electrically connected to a second node between the first node and one first diode of the corresponding pair of first diodes and the second terminal is electrically connected to a third node between the first node and the other first diode of the corresponding pair of first diodes.

22. The three-phase rectifier circuit of claim 20, wherein the voltage source comprises one or more polarized capacitors.

23. The three-phase rectifier circuit of claim 20, wherein each module has a first input, a second input, a first output and a second output, wherein the first input of the first module and the second input of the last module are electrically coupled to the outputs of the PFC circuit, the second input of any one but the last module is electrically connected to the first input of its immediate next module, and all the first outputs and the second outputs of the plurality of modules are electrically parallel-connected.

24. The three-phase rectifier circuit of claim 23, wherein each of the modules comprises a resonant converter.

25. The three-phase rectifier circuit of claim 24, wherein the resonant converter comprises an LLC series resonant DC/DC converter or an LLC parallel resonant DC/DC converter.
